(19) United States
(12) Patent Application Publication
(10) Pub. No.: US 2003/0004808 A1
(43) Pub. Date: Jan. 2, 2003

(54) Method and system for receiving, storing and processing electronic vouchers with a mobile phone or a personal digital assistant

(76) Inventors: Mehdi Elhaoussine, Aix-en-Provence (FR); Nam-Hai Tran Van Bang, Marseille (FR)

Correspondence Address: BANNER & WITCOFF, 1001 G STREET N W, SUITE 1100, WASHINGTON, DC, 20001, US

(21) Appl. No.: 10/181,737

(22) PCT Filed: Nov. 21, 2001
(86) PCT No.: PCT/FR01/03666

(30) Foreign Application Priority Data
Nov. 22, 2000 (FR) 00 15095

(51) Int. Cl. G06F 17/60; H04M 3/42

(52) U.S. Cl. 705/14; 455/414; 705/17

(57) ABSTRACT

The invention concerns a system (1) for receiving, storing and processing electronic vouchers for a consumer equipped with a mobile telephone or a personal digital assistant (2). The mobile tool comprises means (12, 5, 7) for exchanging data with a payment terminal (3) during a purchasing operation, based on an offer of electronic vouchers corresponding to discounts. At least an electronic voucher is received and stored in a storage unit (6) of the mobile tool, the codes (15) of the purchased articles (16) are read at the payment terminal and the list of vouchers stored in the mobile tool is transmitted to the payment terminal. The list of vouchers is compared with the list of purchased articles and if one or several articles are identified for which vouchers exist, the amount of discount(s) corresponding to said vouchers is automatically deducted from the total amount of purchased articles.

This invention relates to a method of receiving, storing and processing electronic coupons with a mobile phone or PDA.

It also relates to a system of receiving, storing and processing electronic coupons.

It has an especially important, although not exclusive, application in the area of loyalty programs intended to encourage consumers to return to the same store or store group.

Systems of obtaining a discount through a paper coupon to be handed over at the cash-desk during the act of purchase are already known. This paper coupon may include a bar code for facilitating its processing. Paper coupons are generally cut out of newspapers or printed out at a kiosk and more recently on a PC.

There are also solutions with chip cards where discount coupons are stored in electronic form in the card's chip. The card is inserted into a reader at the point of sale and the items scanned are compared with the coupons stored in the card's memory.

When a purchased item benefits from a coupon, the system deducts the amount of the discount, prints it on the customer slip then sends the information back to the central server for compensation.

However, the existing systems have drawbacks.

Paper discount coupons require cumbersome and costly management for distributing the offer, using the discount at the point of sale and finally processing the information. The accumulation of paper discount vouchers by the consumer also acts as a curb on their use.

Solutions using a chip card for storing discount coupons require a card to be handed over to the consumer and the presence of a reader for read and/or write processing. The main drawback here is the need to set up an end-to-end hardware infrastructure. Furthermore, when using a card the consumer cannot easily view the coupons stored on the card and the associated validity conditions.

Faced with this gap, the card bearer must therefore, as a necessity, insert his/her card into a device equipped with a reader (kiosk, digital decoder, PC, payment terminal), to receive their discount offers, use them at the point of sale or consult the benefits stored on the card. The list of coupons may then, and for example, be printed at the point of sale by the payment terminal processing the chip card.

The present invention is aimed at remedying these drawbacks and providing a method and a device better at meeting practical requirements than those previously known, especially in enabling consumers to easily benefit from discount coupons to be redeemed at stores or supermarkets, thanks to their mobile phone or equivalent, for example a PDA.

The invention can be used to set up an extremely powerful, easy-to-use method or system which will in particular and for example allow the very accurate measurement of the impact of an advertisement on a consumer.

Thus, a portable device (mobile phone or PDA), an instrument used by the general public, enables the consumer to participate in the stores' loyalty program.

On its part, the store will use the consumer's own portable device to store information and behavioral data about them, which will condition the issue of benefits, without having to create a special storage medium like a loyalty card.

This is because the mobile phone or PDA are portable, secure, mass-distributed objects offering many more facilities than a simple card.

In addition, the mobile phone and the PDA are connected instruments, equipped with a keyboard and a screen, which will enable the consumer to access information about his/her purchasing history and entitlements.

Consulting purchasing history and entitlements can now be done in real time, at any moment, without any complicated administrative procedure, without even resorting to any additional device.

Finally, the store inherits all the previous advantages, enabling it to maximize its chances of securing customer loyalty.

The connected mobile phone can also easily receive promotional offers at any time, anywhere, by simple data reception (example: short message reception). Reception may take place as a result of an “active” procedure on the part of consumers, who select the desired offers on the media of their choice, (so-called “pull” offers or method), or as a result of a “passive” procedure by first communicating their profile and preferences (so-called “push” geomarketing offers or method).

The invention is thus chiefly based first on the idea of becoming free of the card, which assumes a “physical contact” with a reader for receiving the offer and its use at the point of sale, and secondly on the very strong and surprising synergetic effectiveness of the aforementioned “push-pull” procedures.

Accordingly, the invention proposes in particular a method of receiving, storing and processing electronic coupons for a consumer equipped with a mobile device (mobile phone or PDA), said mobile device including means of exchanging data with a payment terminal during a purchase operation, characterized in that, based on electronic coupon offers corresponding to discounts,

at least one electronic coupon is received and stored in a mobile device memory,

the codes of the purchased items are read at the payment terminal,

the list of coupons stored in the mobile device is transmitted to the payment terminal, or conversely the list of items purchased, read off at the payment terminal, is transmitted to the mobile device,

said list of coupons is compared with said list of items purchased,

and if one or more items are identified for which there are one or more coupons, the amount of the discount or discounts corresponding to said coupons is automatically deducted from the total amount of the purchases.

The discount may correspond to the total price of one or more items which will then be regarded as free offers.

In advantageous embodiments one and/or other of the following arrangements are additionally or equally resorted to:

the data is transmitted between the mobile device and the terminal via radio or infrared waves;

the electronic coupon or coupons is/are transmitted to the mobile device via a centralized information server network like the Internet;

for selecting the electronic coupons offer the consumer operates a television remote control, for example during the broadcast of a commercial, the electronic coupon or coupons then being automatically downloaded into the mobile device;

for selecting the electronic coupons offer received directly by the consumer via his/her mobile device, via the Internet, and/or via a kiosk, the consumer operates the keyboard of his/her mobile device;

at the same time as the offer, additional conditions of use on the premises and/or the date of validity, and/or information concerning the product are transmitted, said information being set out to be viewed by the consumer consulting his/her mobile device via the keyboard;

offers are transmitted to the consumer who receives them passively on his/her mobile device according to or not according to a specified profile of said consumer identified by his/her mobile device;

for selecting the electronic coupons offer, the mobile device is located in space and the electronic coupon or coupons is/are transmitted to said mobile device according to the geographical position of said mobile device;

the mobile coupon or coupons is/are downloaded directly close to the payment terminal;

once the deduction has been made, the information is automatically transmitted to a remote server where said information is processed by adding to a behavioral database regarding the mobile device associated with said consumer and/or by incrementing a counter for the store at which said discount has been implemented, to enable said store to be reimbursed for the discount granted to the consumer, substantially in real time;

the consumer consults the set of coupons that he/she has available by manually checking his/her mobile device.

The invention also proposes a system of receiving, storing and processing electronic coupons implementing the method described above.

It also proposes a system of receiving, storing and processing electronic coupons during item purchasing operations at a point of sale by a consumer, the system comprising:

A mobile phone or a PDA equipped with a data memory (SIM card and/or built-in memory, etc.). To simplify matters, only the term mobile phone will be mentioned from now on. But obviously it can be replaced by the term PDA.

A point-of-sale terminal, for example of the electronic cash register type, capable of communicating directly or via a peripheral (payment unit or terminal) with the mobile phone.

A device for reading item codes of purchased items (e.g. bar code scanner or contactless microchip reader)

One or more PC type remote information servers, providing the following functions:

sending discount coupons to the mobile phone (e.g. SMS server),

gathering and processing data relating to point-of-sale transactions,

if necessary, sending data to the mobile phone required for consulting discount coupons and other associated validity conditions on the screen of said phone,

A communications protocol between the mobile phone and the terminal (here the electronic cash register), communication being capable of being direct or via a peripheral (payment unit or terminal) equipped with a communications module.

More specifically, the communications module may be, by way of example, a module using one and/or the other of the following standards:

“SMS” (Short Message Service), which is a standard for short message communications for terminals equipped with a GSM module,

“Bluetooth”, which is a standard for short distance radio-frequency communications,

“IrDa”, which is a communications standard via infrared etc.

A set of software modules providing the following functions:

Sending and receiving coupons on the consumer's mobile phone,

exchanging information between the point-of-sale terminal and the mobile phone,

storing and updating data on the mobile phone,

reading and interpreting information relating to coupons at the point-of-sale terminal,

collecting and processing data relating to point-of-sale transactions,

displaying coupons and associated validity conditions on the mobile phone screen.

The present invention will be better understood on reading the following description of embodiments given as non-restrictive examples.

It refers to the drawings that accompany it in which:

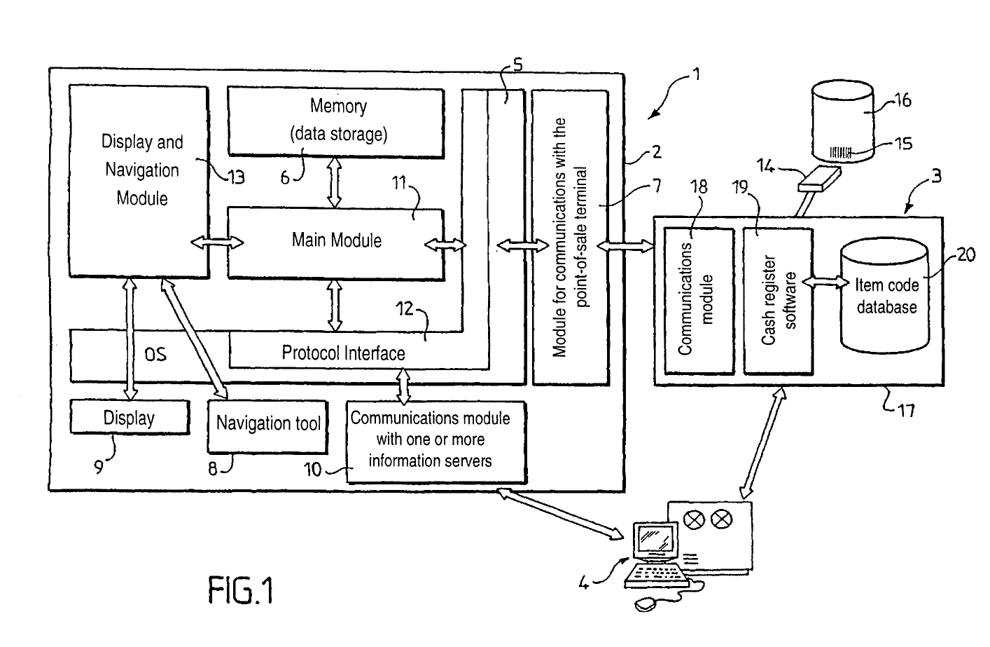

FIG. 1 is a schematic view of a system according to an embodiment of the invention.

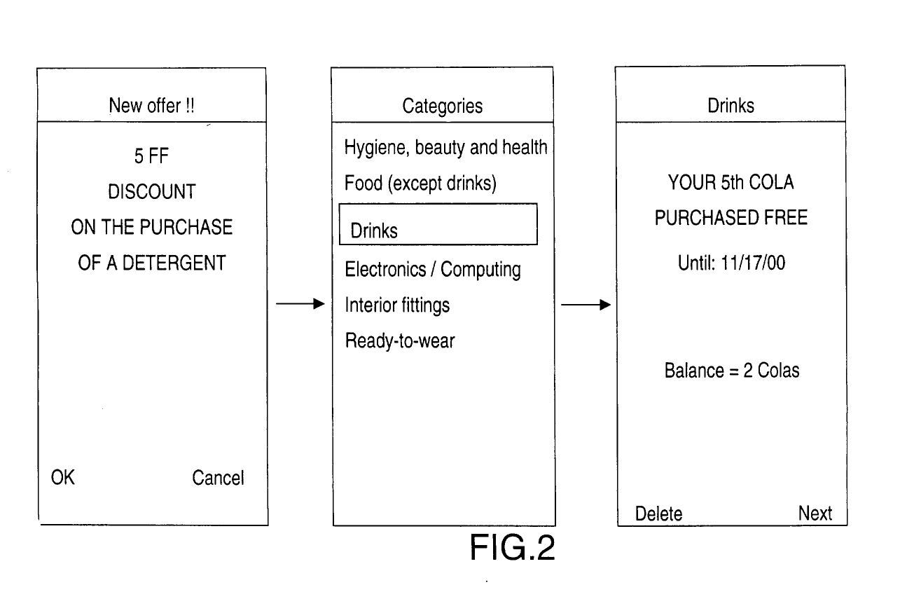

FIG. 2 gives an example of mobile phone consultation screens, used in an embodiment of the invention.

FIG. 1 shows a system 1 including a mobile or portable phone 2 or a similar device of the PDA type, point-of-sale or payment terminal 3 of the electronic cash register type, one or more remote centralized information servers 4.

The phone 2 includes, either built-in, or as a peripheral:

An operating system 5,

a memory 6 for storing built-in memory and/or SIM card type data,

a module 7 for communications and data exchange with the point-of-sale terminal 3 of the type with exchange via infrared (IrDa type), radio-frequency (Bluetooth type), short message (SMS type), etc.

a navigation tool 8 (voice, touch and/or manual) and a display screen 9,

a communications module 10 for accessing the information from remote servers 4 and receiving data,

software modules including:

a main module 11 responsible first for translating the external information received from the point-of-sale terminal 3 or from the information server 4, updating the data stored in the memory 6 and sending the information required by the point-of-sale terminal 3, via the intermediary of the protocol interface 12, and secondly for translating the data stored in the memory 6, possibly comparing them with those contained in the server 4, via the intermediary of the protocol interface 12, and distributing this information to the display and navigation module 13,

said display and navigation module 13, responsible for displaying this information on the display screen 9, and for consultation of the various coupons thanks to the navigation tool 8.

The point-of-sale terminal 3 itself includes, either built-in, or as a peripheral:

A system 14, known in itself, of reading codes 15 on the items 16, which can be used for example to scan the bar code 15 printed on said purchased items

a cash register 17 consisting of three main modules, namely: a communications module 18 for exchanging data with the portable phone 2, a cash register software program 19 which will process all the information linked to the items scanned and to the associated discount coupons and, a database 20 containing the information associated with each of the item codes.

In some cases, where it is not possible to communicate directly with the portable phone 2, the cash register 17 may be connected to a peripheral, payment unit or terminal (not shown), capable of communicating with the portable phone and transmitting the information to or from the point-of-sale terminal 3.

We are now going to describe as an example of operation, the issue of a discount coupon for redeeming in a supermarket chain.

To do so, the electronic coupons are first of all received and stored according to one and/or the other of the following methods of reception:

A. Selection of Discount Coupons or Promotional Offers: So-Called “PULL” Method

The offer is selected here on a chosen interactive medium, that is, for example:

selection on the phone screen on a WAP (wireless protocol application) compatible site connected to the Internet.

selection on a PC connected to the Internet, by specifying from the coupons offered on the site, the offer or offers that are wanted,

selection of the discount coupon on an interactive kiosk,

selection of the coupon on an interactive television, either from a list of proposed offers, or by operating a remote control when a commercial is being broadcast.

At that time, the consumer (TV viewer) automatically receives in his/her mobile phone, in standby state, the promotional offer (or electronic discount coupon) associated with the product or with the product range shown in this commercial.

The selection of a discount coupon during a commercial may also and for example be accompanied by additional information on the product in question thanks to the sending of a link to an Internet site. This link is received on the consumer's electronic mail system (e-mail system of a WAP phone, PC or television with access to the Internet or WebTV).

For example (see FIG. 2), the consumer chooses the following discount coupons:

“5 francs discount on the sale of a detergent” by navigating around on his/her WAP phone;

“1 packet of coffee FREE for 2 packets purchased” on an Internet site specializing in couponing;

“The 5th soda bought before Nov. 17, 2000 is FREE”,

by activating a function of his/her remote control when a commercial is broadcast on the television extolling the merits of a famous brand of soda.

Each offer is then and for example subject to additional conditions of use such as the date of validity, the premises for use etc. Selecting a discount coupon can thus entail the simultaneous sending of information about the product.

B. Receiving Targeted Offers: So-Called “PUSH” Method

In this case, the consumer receives his/her offers passively.

In an advantageous embodiment the consumer can also indicate his/her preferences and/or his/her profile, thus the offers broadcast by the advertisers are then better targeted and therefore of greater perceived value.

There are also other methods for targeting promotional offers, like “geomarketing”.

This concept is a good example of what the method and system according to the invention can be used for.

It is based on location techniques, which offer the possibility of locating a mobile phone in space, and sending it suitable offers according to its geographical position and profile, subject to respecting the applicable privacy protection laws in the case in point.

Here, for example, the consumer's agreement must be sought to prevent the sending of unwanted promotional offers.

C. Discount Coupons can also be Issued at the Point of Sale.

To do this, the products concerned are scanned for example and a downloaded coupon is obtained in the mobile phone directly at the point of sale.

Here it is also possible to receive discount coupons at the point-of-sale terminal itself.

These promotional offers are then and for example issued randomly or in accordance with predetermined conditions linked to the consumer's profile, where the consumer is recognized by the point-of-sale terminal from the information stored in his/her portable phone.

In the embodiment more specifically described here, sending offers to the consumer's portable phone and storing the information takes place in the following way:

The consumer is identified by his/her phone number, this number being capable of being supplemented with certain information such as their name, e-mail address, etc.

The offer or offers selected by the identified consumer are then sent to an information server, which will be responsible for transmitting the discount offer to the consumer's phone. This transmission can be carried out via so-called SMS simple short messages. The consumer receives the discount offer on the screen of his/her portable phone, a key on the keyboard is used to validate the acceptance of this offer and store it in the phone's memory (built-in memory, SIM card or other).

Once the electronic coupon or coupons have been received, they will be able to be used for example as follows:

When the consumer has made his/her choice of items, he/she goes to the point of sale.

The item codes are then read on the cash register (bar code scanner, contactless microchip reading, etc.) then the consumer's portable phone enters into communication with the point-of-sale terminal (or an intermediate peripheral).

This communication may be initiated by the customer who, using an appropriate key, sends the coupons that he/she holds for processing by the cash register, or by the cash register itself, which will send a request to the portable phone to receive the valid offers at this point of sale.

The data exchange between the phone and the cash register uses, as we have seen, Bluetooth, IrDa or SMS technologies.

Then the cash register compares the list of coupons transmitted by the portable phone with the list of items read.

If it identifies an item to which a promotional coupon applies, the amount of the discount is automatically deducted from the total amount of the purchases, the information is retranscribed onto the till slip and the discount coupon sent to the information server for processing.

For some discount coupons of the “5^{th} soda purchased is free” type, an item counter is included in the information relating to the coupon, this counter is updated in the phone memory thanks to the cash register, which sends back the information, so long as the coupon remains valid (here, purchase of 5 sodas in the month).

The system then processes and uses the information according to the embodiment of the invention specifically described here.

The use of a coupon here, in fact, gives rise to a feedback of information to the central server 4.

This information may be used to compensate the face value of the coupon, i.e. to reimburse the store for the amount of the discount granted to the customer. In addition, using these data offers a level of knowledge regarding the purchasing behavior of an identified consumer. These analyses may also be used to refine the targeting of offers and to better segment the transmission of new offers. The process is naturally enhanced through the effect of experience.

According to an advantageous embodiment, the consumer will be able to view and consult his/her set of available electronic coupons.

This means that the portable phone screen can be used to consult coupons stored in the phone memory, the conditions of obtaining coupons being for example explicitly viewed on the screen of the portable phone as shown with reference to FIG. 2.

The operation of the system and the method according to the specifically envisaged embodiment of the invention will now be described.

The discount coupons are received on the phone 2 from one or more information servers 4 thanks to the communications module 10 and via the interface 12. The main module 11 retrieves the data associated with the coupon(s) for storing them in the memory 6.

At the point of sale, the purchased items are read or scanned at the cash register 17 by a bar code reader or any other reading device 14, then the consumer's portable phone enters into communication with the point-of-sale terminal 3 (directly or via an intermediate peripheral). This communication may be initiated by the customer who, using an appropriate key, sends the coupons that he/she holds for processing by the cash register, or by the cash register itself, which then sends a request to the portable phone 2 to receive the valid discount offers at this point of sale.

The main module 11 processes the request and sends back the list of coupons contained in the memory 6 thanks to the communications module 7 via the protocol interface 12.

As already seen, the data exchange between the phone 2 and the cash register 17 uses Bluetooth, IrDa or SMS type technologies. Communication between the point-of-sale terminal 3 and the portable phone 2 takes place thanks to the communications modules 7 and 18 via the protocol interface 12.

The initialization of communications between the portable phone 2 and the payment terminal or point-of-sale terminal 3 is carried out by simple pointing (point-to-point communications) in the case of an infrared link, in the case of “Bluetooth” technology the identification and synchronization between the two instruments is performed by frequency negotiation within a master/slave type relationship. Finally, short message communications require dialing a phone number to set up the link and information exchange.

Subsequently, the cash register 17, thanks to its internal software 19, compares the list of coupons transmitted by the portable phone 2 with the list of items read or scanned by the reader 14. Other systems of reading may be envisaged, like, for example, resorting to so-called contactless reading of item codes thanks to the use of a microchip affixed to the product itself.

When an item is identified, to which a promotional coupon applies, the amount of the discount is automatically deducted from the total amount of the purchases, the information being retranscribed onto the till slip.

The information collected at the time of the transaction is then transmitted to the information server 4 for processing.

The main module 11 itself retrieves the information returned by the point-of-sale terminal 3 and updates the data in the memory 6.

For some discount coupons of the “5^{th} soda purchased is free” type, an item counter is included in the information relating to the coupon, this counter being updated in the phone memory 6 thanks to the cash register 3, which sends back the information, so long as the coupon validity criterion is met (here, purchase of 5 sodas in the month).

As stated previously, the consumer can also receive discount coupons at the point-of-sale terminal 3, either randomly or according to well-defined criteria (consumer profile, loyalty program, etc.). These coupons are themselves also stored in this same coupons file contained in the memory 6 of the portable phone 2 thanks to the main module 11, which processes the information originating from the communications module 7 via the interface 12.

To enable consultation by a consumer, the main module 11 accesses the information contained in the memory 6 of the phone 2. When the information contained in the memory is exhaustive, it distributes this data to the display and navigation module 13.

When the information contained in the memory 6 is partial, and the main module is advantageously set up to obtain the missing information by means of a remote interrogation of the information server 4 via the intermediary of the communications module 10 and the protocol interface 12. The main module then compares the information from the memory 6 with that originating from the server, then distributes it to the display and navigation module 13.

After receiving these data, the display and navigation module 13 formats them and transmits them to the display 9 for viewing. These data may then be consulted by the bearer using the navigation tool 8.

We are now going to describe the information contained in the memory of the phone or mobile device belonging to the system specifically envisaged here.

This information contained in the memory 6 of the phone 2 is distributed in the following files:

The General File

This contains the phone and/or operator description information, and in particular:

An identification number for the phone and/or the SIM card.

The name of the operator (or an identifier enabling it to be retrieved).

The validity date of the subscription.

The Consumer File

This contains the description information of the phone's owner, such as:

The owner's name.

An identification number for the holder (such as a subscription number).

Demographic information, such as date of birth, his/her address, etc.

Biometric information, such as the holder's size, etc.

The Coupons File

This is used to store the discount coupon(s) in the phone memory for later use. From the information contained in this file, among other things and for example the following are retrieved:

An offer identifier

A coupon identification code

The coupon validity date

The descriptive text or label of the coupon

An identifier of the acceptance network

In the case of cumulative purchases over time (e.g. 5^{th} cola purchased before December 31 free):

The number of items required for validating the discount coupon

An item counter

The So-Called RFM (Recency, Frequency, Monetary Value) File

This stores purchasing behavior history, such as the running total of amounts spent for each of the stores frequented by the possessor of the portable phone.

This file is structured into records, each record containing information specific to the loyalty program(s) of a store (or of several of them when the loyalty program is common to several stores).

Each record contains:

A loyalty program identification number,

The type of loyalty program practiced by this store,

The expiration date of the loyalty program,

The date of the last visit made to this store,

The number of visits made to this store,

The running total of the purchases made at this store,

In certain cases the cumulative number of items purchased at this store (e.g. # pizzas).

The Points File

This stores the running total of loyalty points acquired by the possessor of the portable phone at one or more stores (in the case where the benefit takes the form of issuing loyalty points of the cumulative promotional unit type, exchangeable against a reward).

As is obvious and as emerges moreover from the foregoing, the present invention is not restricted to the envisaged embodiments.

On the contrary, it embraces all variants and especially those where the mobile device is a watch, where the keyboard of the mobile device is a touch screen and where the communications protocols between servers, phone and point of sale are different from those specifically described.

1. Method of receiving, storing and processing electronic coupons for a consumer equipped with a mobile phone or PDA, hereafter called a mobile device (2), the mobile device including means (7) of exchanging data with a payment terminal (3) during a purchase operation, characterized in that, based on electronic coupon offers corresponding to discounts,
at least one electronic coupon is received and stored in a mobile device (2) memory (6),
the codes (15) of the purchased items (16) are read at the payment terminal,
the list of coupons stored in the mobile device (2) is transmitted to the payment terminal (3), or conversely the list of items purchased, read off at the payment terminal, is transmitted to the mobile device (2).
said list of coupons is compared with said list of items purchased,
and if one or more items are identified for which there are one or more coupons, the amount of the discount or discounts corresponding to said coupons is automatically deducted from the total amount of the purchases.

2. Method of receiving, storing and processing as claimed in claim 1, characterized in that the data is transmitted between the mobile device (2) and the terminal (3) via radio or infrared waves.

3. Method as claimed in any of the preceding claims, characterized in that the electronic coupon or coupons is/are transmitted to the mobile device via a centralized information server network (4).

4. Method as claimed in claim 3, characterized in that, for selecting the electronic coupons offer, the consumer operates a television remote control during the broadcast of a commercial, the electronic coupon or coupons then being automatically downloaded into the mobile device.

5. Method as claimed in either of claims 3 and 4, characterized in that, for selecting the electronic coupons offer received directly by the consumer via his/her mobile device (2), via the Internet, and/or via a kiosk, the consumer operates the keyboard (8) of his/her mobile device (2).

6. Method as claimed in any of claims 3, 4 and 5, characterized in that at the same time as the offer, additional conditions of use on the premises and/or the date of validity, and/or information concerning the product are transmitted, said information being set out to be viewed by the consumer consulting his/her mobile device (2) via the keyboard (8).

7. Method as claimed in any of the preceding claims, characterized in that the offers are transmitted to the consumer who receives them passively on his/her mobile device (2) according to or not according to a specified profile of said consumer identified by his/her mobile device.

8. Method as claimed in any of the preceding claims, characterized in that, for selecting the electronic coupons offer, the mobile device is located in space and the electronic coupon or coupons is/are transmitted to said mobile device according to the geographical position of said mobile device.

9. Method as claimed in any of the preceding claims, characterized in that the mobile coupon or coupons is/are downloaded directly close to the payment terminal (3).

10. Method as claimed in any of the preceding claims, characterized in that, once the deduction has been made, the information is automatically transmitted to a remote server (4) where said information is processed by adding to a behavioral database regarding the mobile device (2) associated with said consumer and/or by incrementing a counter for the store at which said discount has been implemented, to enable said store to be reimbursed for the discount granted to the consumer, substantially in real time.

11. Method as claimed in any of the preceding claims, characterized in that the consumer consults the set of coupons that he/she has available by manually checking his/her mobile device.

12. System (1) of receiving, storing and processing electronic coupons during item purchasing operations at a point of sale by a consumer, the system comprising:
a payment terminal (3),
a device (14) for reading item codes of purchased items, and
one or more remote information servers (4), characterized in that it further comprises at least a mobile phone or a PDA, hereafter called mobile device (2), associated with said consumer, equipped with a data memory (6) and means (5, 7, 12) set up for communicating with the payment terminal,
said information server or servers (4) including means arranged to ensure the functions of sending discount coupons to the mobile device (2), and of collecting and processing data relating to purchasing operations at the point of sale,
and in that the mobile device (2) and/or the payment terminal (3) include:
means of communication (7) between the mobile device and the payment terminal,
means (11) of programmed calculation and processing for providing the following functions:
Sending and receiving coupons on the consumer's mobile phone,
exchanging information between the point-of-sale terminal and the mobile device,
storing and updating data on the mobile device,
reading and interpreting information relating to electronic coupons,
collecting and processing data relating to purchasing operations.

13. System as claimed in claim 12, characterized in that the mobile device includes means (8, 9) of displaying coupons and associated validity conditions, enabling the consumer to consult the set of discount coupons and other associated validity conditions.

14. System as claimed in either of claims 12 and 13, characterized in that the means of communication (7) between the mobile device and the payment terminal are set up to enable communication via radio or infrared waves.

15. System as claimed in any of claims 12 to 14, characterized in that it includes means of selecting discount coupons or promotional offers via an interactive medium on a WAP-compatible site connected to the Internet, on a PC connected to the Internet, or on an interactive kiosk.

16. System as claimed in any of claims 12 to 15, characterized in that it further includes means of selecting the coupon on an interactive television, either from a suggested list of offers, or by operating a remote control during the broadcasting of a commercial, the mobile device being set up to automatically receive the promotional offer associated with the product or with the range of products presented in this advertisement.

17. System as claimed in any of claims 12 to 16, characterized in that it includes means (10, 4) of transmitting behavioral and/or loyalty data on the consumer from the remote server (4).

18. System as claimed in any of claims 12 to 17, characterized in that, the consumer receiving the offers passively, it includes means of communicating his/her preferences and/or his/her profile.

19. System as claimed in any of claims 12 to 18, characterized in that it includes means of locating the mobile device in space, and means of transmitting suitable offers according to the geographical position of said mobile device.

20. System as claimed in any of claims 12 to 19, characterized in that it includes means of sending discount coupons at the point of sale, set up to scan the products concerned and download a coupon into the mobile device directly at the point of sale, said coupons being sent randomly or in accordance with predetermined conditions linked to the consumer's profile, the consumer being recognized by the point-of-sale terminal from the information stored in the mobile device.

21. System as claimed in any one of claims 12 to 20, characterized in that the memory (6) of the mobile device includes a General file containing the descriptive information of the mobile device and/or the operator, a Consumer file containing descriptive information on the phone owner, a Coupons file for storing the discount coupon or coupons in the memory, a so-called RFM file containing behavioral and loyalty data on the consumer, and possibly a Points file storing, where applicable, the running total of loyalty points acquired by the owner of the mobile device at one or more stores.
